(19) United States
(12) Patent Application Publication
(10) Pub. No.: US 2013/0206669 A1
(43) Pub. Date: Aug. 15, 2013

(54) Filter Endcap With Integral Seal, Filter Assembly and Methods for Manufacturing the Same

(71) Applicant: Wix Filtration Corp LLC, (US)

(72) Inventor: Mitchell Jerome Baker, Dallas, NC (US)

(73) Assignee: Wix Filtration Corp LLC, Gastonia, NC (US)

(21) Appl. No.: 13/804,315

(22) Filed: Mar. 14, 2013

Related U.S. Application Data
(63) Continuation-in-part of application No. 13/196,486, filed on Aug. 2, 2011.

(51) Int. Cl. B01D 35/30; B29C 39/10

(52) U.S. Cl. CPC B01D 35/30; B29C 39/10
USPC 210/232; 210/541; 210/435; 264/259

(57) ABSTRACT

A sub-assembly is disclosed. The sub-assembly includes an endcap connected to a seal member. The endcap includes a body, an outer circumferential lip connected to a first end of the body, and an inner circumferential lip body connected to a second end of the body. The inner circumferential lip body defines a groove. The inner circumferential lip body extends away from and beyond a top surface of the body and a lower portion extending away from and beyond a bottom surface of the body of the endcap. The seal member includes a body, and a circumferential lip connected to the body of the seal member. The body of the seal member includes a top surface and a bottom surface. The top surface of the body of the seal member includes a recess. The inner circumferential lip body of the endcap is arranged within the recess of the seal member. A portion of a filter assembly is also disclosed. A method for manufacturing at least a sub-assembly of a filter assembly is also disclosed. A method for manufacturing at least a portion of a filter assembly is also disclosed.

### CROSS-REFERENCE TO RELATED APPLICATIONS

This U.S. patent application is a continuation-in-part of U.S. patent application Ser. No. 13/196,486 filed on Aug. 2, 2011, the disclosure of which is considered part of the disclosure of this application and is hereby incorporated by reference in its entirety.

### FIELD

The invention relates to filters.

### BACKGROUND

Various filters are known in the art for filtering fluid as it passes through a fluid path. Filters include, in part, filter media which removes impurities from a fluid, such as, for example, oil or fuel that passes through filter media.

In most applications, either the filter or the filter media associated therewith must be periodically replaced to reduce the potential of developing unacceptably high impedance in the fluid path flow restriction.

While known filters have proven to be acceptable for various applications, such conventional filters are nevertheless susceptible to improvements that may enhance their overall performance and cost. Therefore, a need exists to develop improved filters that advance the art.

### BRIEF DESCRIPTION OF THE DRAWINGS

The present disclosure will now be described, by way of example, with reference to the accompanying drawings, in which:

FIG. 1A is an assembled, side partial cross-sectional view of a filter assembly in accordance with an exemplary embodiment of the invention;

FIG. 1B is an exploded, side cross-sectional view of the filter assembly of FIG. 1A;

FIG. 2A is a partial perspective, exploded view of an end cap and filter media of the filter assembly of FIGS. 1A-1B arranged above a mold tool component;

FIG. 2B is another partial perspective view of the portion of the end cap and filter media of FIG. 2A arranged adjacent the mold tool component of FIG. 2A;

FIG. 2C is a partial perspective, assembled view of a portion of the filter assembly of FIG. 2A including the endcap, filter media and a seal member arranged above the mold tool component of FIG. 2A;

FIG. 3A is a cross-sectional view of an endcap according to line 3A-3A of FIG. 2A in accordance with an exemplary embodiment of the invention;

FIG. 3B is an enlarged cross-sectional view of the endcap according to line 3B of FIG. 3A;

FIG. 4A is a cross-sectional view of a seal member of the filter assembly of FIGS. 1A-1B in accordance with an exemplary embodiment of the invention;

FIG. 4B is an enlarged cross-sectional view of the endcap according to line 4B of FIG. 4A;

FIG. 5 is a cross-sectional view of a mold tool component according to line 5-5 of FIG. 2A in accordance with an exemplary embodiment of the invention;

FIG. 6A illustrates a cross-sectional view of the endcap of FIG. 3A arranged adjacent the mold tool component of FIG. 5 in accordance with an exemplary embodiment of the invention;

FIG. 6B illustrates a cross-sectional view of the endcap arranged adjacent the mold tool component of FIG. 6A with a material being deposited over a portion of the endcap and the mold tool component in accordance with an exemplary embodiment of the invention;

FIG. 6C illustrates a cross-sectional view of the endcap arranged adjacent the mold tool component with the material deposited over the portion of the endcap and the mold tool component of FIG. 6B for forming a seal member in accordance with an exemplary embodiment of the invention;

FIG. 7A is a partial cross-sectional view of filter media of FIGS. 1A-2A arranged above the mold tool component including the material forming the seal member of FIG. 6C in accordance with an exemplary embodiment of the invention;

FIG. 7B is a cross-sectional view according to line 7B-7B of FIG. 2B including a portion of the filter media arranged in the material forming the seal member of FIG. 7A in accordance with an exemplary embodiment of the invention; and

FIG. 7C is a cross-sectional view according to line 7C-7C of FIG. 2C including a portion of the filter assembly including the filter media connected to the endcap by way of the material forming the seal member being removed from the mold tool component in accordance with an exemplary embodiment of the invention.

FIG. 8A is an assembled, side partial cross-sectional view of a filter assembly in accordance with an exemplary embodiment of the invention;

FIG. 8B is an exploded, side cross-sectional view of the filter assembly of FIG. 8A;

FIG. 9A is a partial perspective, exploded view of an end cap and filter media of the filter assembly of FIGS. 8A-8B arranged above a mold tool component;

FIG. 9B is another partial perspective view of the portion of the end cap and filter media of FIG. 9A arranged adjacent the mold tool component of FIG. 9A;

FIG. 9C is a partial perspective, assembled view of a portion of the filter assembly of FIG. 9A including the endcap, filter media and a seal member arranged above the mold tool component of FIG. 9A;

FIG. 10A is a cross-sectional view of an endcap according to line 10A-10A of FIG. 9A in accordance with an exemplary embodiment of the invention;

FIG. 10B is an enlarged cross-sectional view of the endcap according to line 10B of FIG. 10A;

FIG. 11A is a cross-sectional view of a seal member of the filter assembly of FIGS. 8A-8B in accordance with an exemplary embodiment of the invention;

FIG. 11B is an enlarged cross-sectional view of the endcap according to line 11B of FIG. 11A;

FIG. 12 is a cross-sectional view of a mold tool component according to line 12-12 of FIG. 9A in accordance with an exemplary embodiment of the invention;

FIG. 13A illustrates a cross-sectional view of the endcap of FIG. 10A arranged adjacent the mold tool component of FIG. 12 in accordance with an exemplary embodiment of the invention;

FIG. 13B illustrates a cross-sectional view of the endcap arranged adjacent the mold tool component of FIG. 13A with a material being deposited over a portion of the endcap and the mold tool component in accordance with an exemplary embodiment of the invention;

FIG. 13C illustrates a cross-sectional view of the endcap arranged adjacent the mold tool component with the material deposited over the portion of the endcap and the mold tool component of FIG. 13B for forming a seal member in accordance with an exemplary embodiment of the invention;

FIG. 14A is a partial cross-sectional view of filter media of FIGS. 8A-9A arranged above the mold tool component including the material forming the seal member of FIG. 13C in accordance with an exemplary embodiment of the invention;

FIG. 14B is a cross-sectional view according to line 14B-14B of FIG. 9B including a portion of the filter media arranged in the material forming the seal member of FIG. 14A in accordance with an exemplary embodiment of the invention; and

FIG. 14C is a cross-sectional view according to line 14C-14C of FIG. 9C including a portion of the filter assembly including the filter media connected to the endcap by way of the material forming the seal member being removed from the mold tool component in accordance with an exemplary embodiment of the invention.

### DETAILED DESCRIPTION

The Figures illustrate exemplary embodiments of a filter endcap with integral seal, a filter assembly and methods for manufacturing the same in accordance with embodiments of the invention, and, based on the foregoing, it is to be generally understood that the nomenclature used herein is simply for convenience and the terms used to describe the invention should be given the broadest meaning by one of ordinary skill in the art.

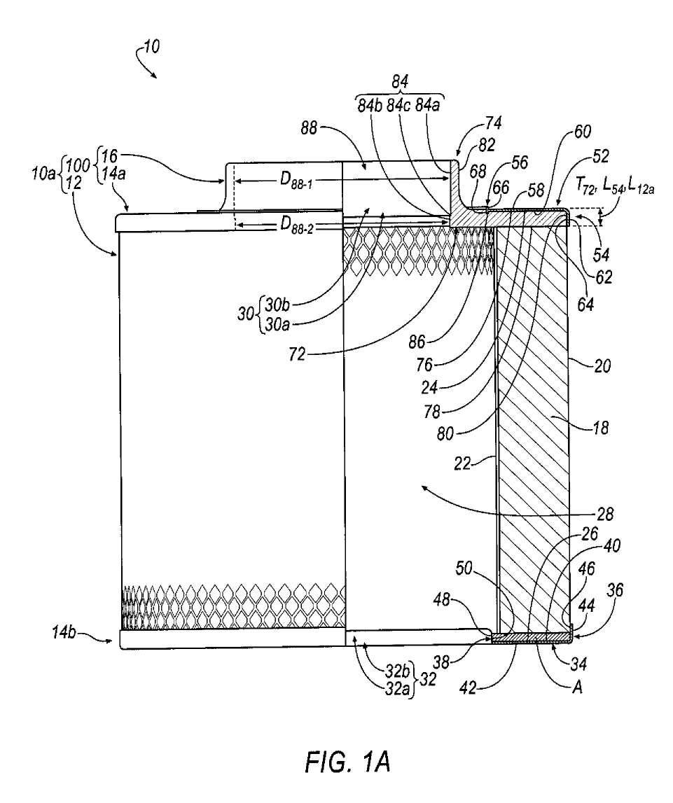

Referring to FIGS. 1A-1B, a filter assembly is shown generally at 10 in accordance with an exemplary embodiment of the invention. The filter assembly 10 includes filter media 12, a first or upper endcap cap 14a, a second a lower endcap 14b and a seal member 16.

As will be explained in the following disclosure, the first or upper endcap cap 14a and the seal member 16 may form a sub-assembly 100 (see, e.g., FIGS. 1B, 6C and 7A) of the filter assembly 10. Subsequent attachment of the filter media 12 to the sub-assembly 100 may form a portion 10a of the filter assembly 10 (see, e.g., FIGS. 1B, 2B-2C, 7A-7C). Referring to FIG. 1B, the second or lower endcap 14b may be attached to the portion 10a (by way of, e.g., attaching material, A, such as, for example, an adhesive, potting compound, or the like) for forming the filter assembly 10.

Referring to FIGS. 1A-1B, the filter media 12 may include a body 18. The body 18 includes an outer surface 20, an inner surface 22, a first or upper end surface 24 and a second or lower end surface 26. The body 18 may include any desirable geometry or shape such as, for example, a ring shape, a cylindrical shape, a tube shape or the like.

The inner surface 22 forms a passage 28 extending through the body 18. The first or upper end surface 24 forms a first or upper opening 30a in the body 18. The second or lower end surface 26 forms a second or lower opening 32a in the body 18. The first or upper opening 30a and the second or lower opening 32a each provide access to the passage 28.

The second or lower endcap 14b may include a body 34 connected to an outer circumferential lip 36 and an inner circumferential lip 38. The body 34 includes a top surface 40 and a bottom surface 42. The outer circumferential lip 36 includes an outer surface 44 and an inner surface 46. The inner circumferential lip 38 includes an outer surface 48 and an inner surface 50. The outer surface 48 of the inner circumferential lip 38 of the second or lower endcap 14b forms an opening 32b.

The second or lower opening 32a in the body 18 of filter media 12 and the opening 32b of the second or lower endcap 14b may be one-in-the same in that both openings 32a, 32b provide access to the passage 28 extending through the body 18 of filter media 12. Accordingly, the openings 32a, 32b may be collectively referred to as a lower opening 32 (see, e.g., FIG. 1A).

The top surface 40 of the body 34 of the second or lower endcap 14b may be disposed substantially adjacent and connected to the second or lower end surface 26 of the filter media 12. The top surface 40 of the body 34 of the second or lower endcap 14b may be connected to the second or lower end surface 26 of the filter media 12 with any desirable attaching material, A, such as, for example, an adhesive, potting compound or the like.

The inner surface 46 of the outer circumferential lip 36 of the second or lower endcap 14b may be in a spaced-apart relationship with the outer surface 20 of the filter media 12. Alternatively, the inner surface 46 of the outer circumferential lip 36 of the second or lower endcap 14b may be in an adjacent relationship with the outer surface 20 of the filter media 12.

The inner surface 50 of the inner circumferential lip 38 of the second or lower endcap 14b may be in a spaced-apart relationship with the inner surface 22 of the filter media 12. Alternatively, the inner surface 50 of the inner circumferential lip 38 of the second or lower endcap 14b may be in an adjacent relationship with the inner surface 22 of the filter media 12.

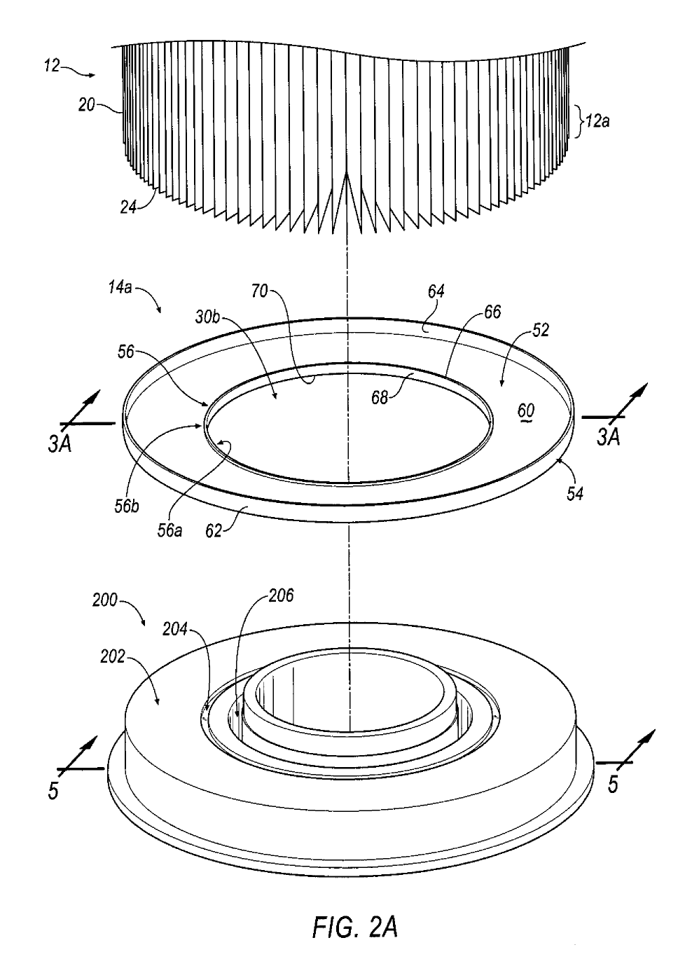

Referring to FIGS. 1A-1B and 3A, the first or upper endcap 14a is shown. FIGS. 1A-1B may be described as being a “right-side-up” view of the first or upper endcap 14a whereas FIG. 3A may be described as being an “up-side-down” view of the first or upper endcap 14a. Accordingly, when words such as, for example, “upper,” “top” or “bottom” are used to describe features of the first or upper endcap 14a, the “right-side-up” view of FIGS. 1A-1B is utilized as a frame of reference for describing features of the first or upper endcap 14a; however, when FIG. 3A is referenced, the use of the words “upper,” “top” and “bottom” (from describing FIGS. 1A-1B) are maintained for consistency. Thus, based on the foregoing, it is reminded that the nomenclature used herein is simply for convenience and the terms (e.g., “upper,” “top,” “bottom” and the like) used to describe the invention should be given the broadest meaning by one of ordinary skill in the art.

Referring to FIGS. 1A-1B and 3A, the first or upper endcap 14a may include a body 52 connected to an outer circumferential lip 54 and an inner circumferential lip 56. The body 52 includes a top surface 58 and a bottom surface 60. The outer circumferential lip 54 includes an outer surface 62 and an inner surface 64.

Referring also to FIG. 3B, the inner circumferential lip 56 includes an inner surface 66 and an outer surface 68. The outer surface 68 of the inner circumferential lip 54 of the first or upper endcap 14a forms an upper opening 30b.

The first or upper opening 30a in the body 18 of the filter media 12 and the opening 30b of the first or upper endcap 14a may be one-in-the same in that both openings 30a, 30b provide access to the passage 28 extending through the body 18. Accordingly, the openings 30a, 30b may be collectively referred to as an upper opening 30 (see, e.g., FIG. 1A).

The inner surface 64 of the outer circumferential lip 54 of the first or upper endcap 14a may be in a spaced-apart relationship with the outer surface 20 of the filter media 12. Alternatively, the inner surface 64 of the outer circumferential lip 54 of the first or upper endcap 14a may be in an adjacent relationship with the outer surface 20 of the filter media 12.

The inner surface 66 of the inner circumferential lip 56 of the first or upper endcap 14a may be in a spaced-apart relationship with the inner surface 22 of the filter media 12. Alternatively, the inner surface 66 of the inner circumferential lip 56 of the first or upper endcap 14a may be in an adjacent relationship with the inner surface 22 of the filter media 12.

Referring to FIG. 3B, a first or upper portion 56a of the inner circumferential lip 56 may extend away from and beyond the top surface 58 of the body 52 of the first or upper endcap 14a. A second or lower portion 56b of the inner circumferential lip 56 may extend away from and beyond the bottom surface 60 of the body 52 of the first or upper endcap 14a.

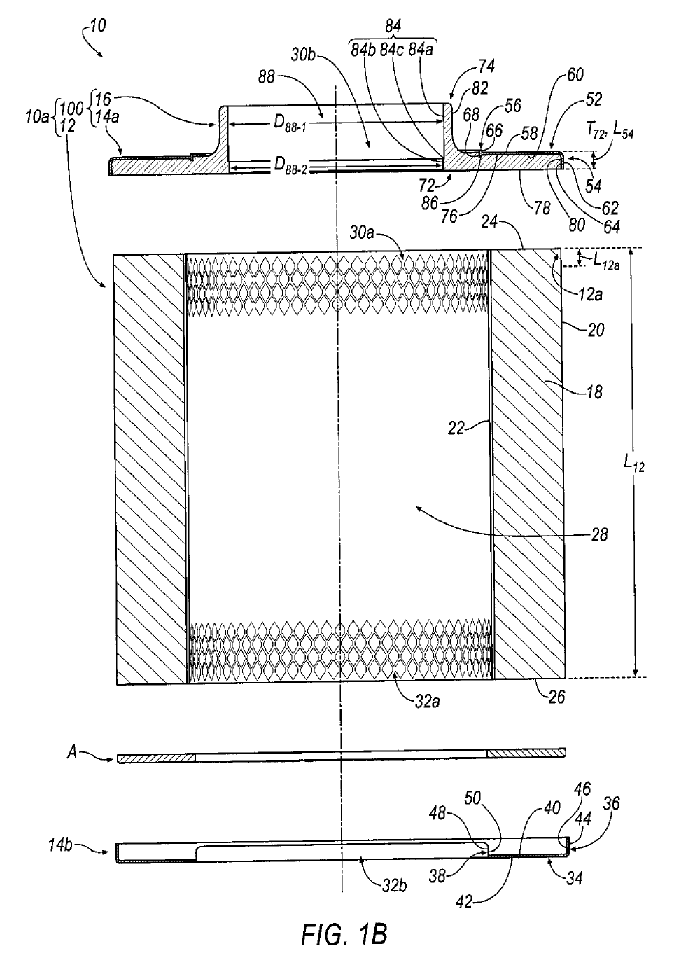

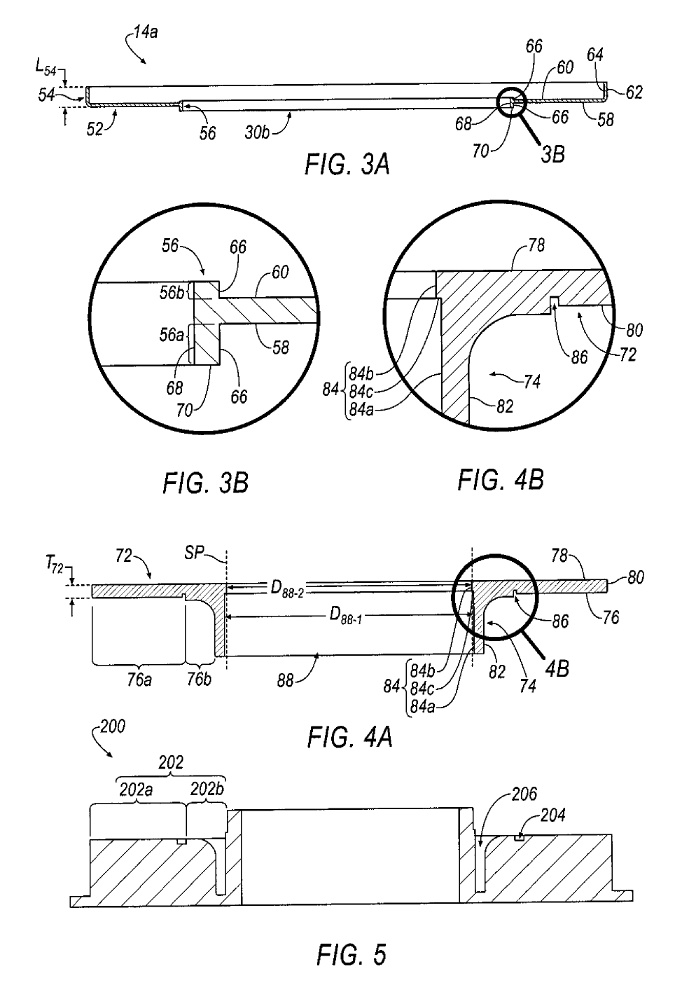

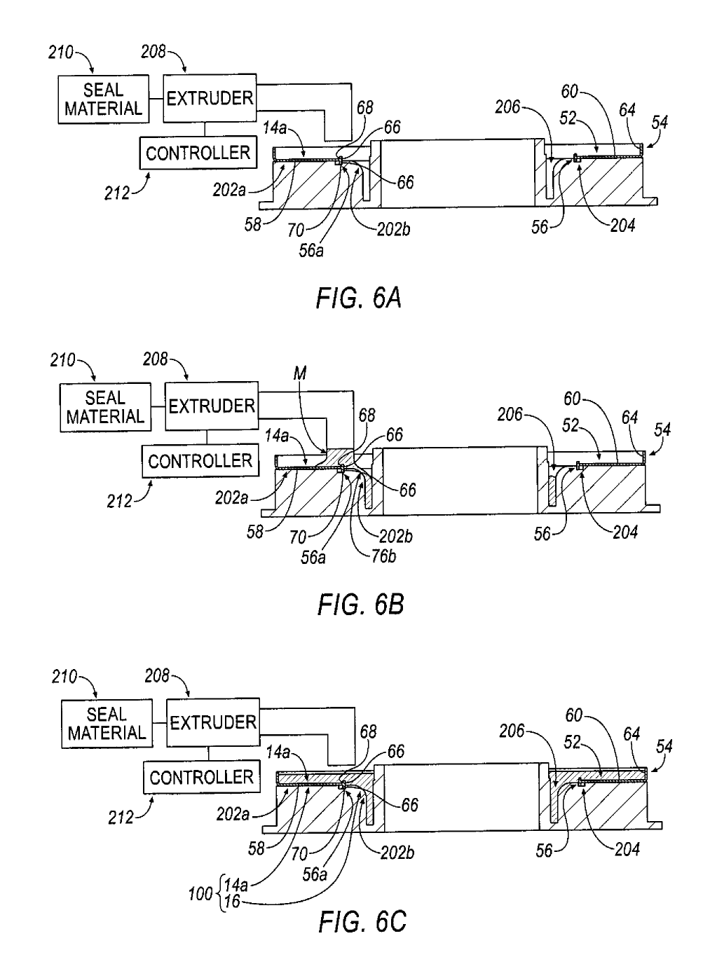

As will be described in the following disclosure at FIG. 6A, the first or upper portion 56a of the inner circumferential lip 56 may form a male portion or locating rib having a top surface portion 70 (see, e.g., FIG. 3B) that interfaces with a mold tool component (see, e.g., 200 of FIGS. 2A-2C, 5). The male portion or locating rib 56a interfaces with a female portion, groove or recess (see, e.g., 204) formed by the mold tool component 200. Accordingly, upon arranging the male portion or locating rib 56a formed by the inner circumferential lip 56 within a female portion or recess 204 formed in the mold tool component 200, the first or upper endcap 14a may be controllably-positioned (e.g., centrally positioned) upon the mold tool component 200 in order to, for example, ensure accurate repeatability of a formation (e.g., an over-molding) of plurality of sub-assemblies 100 including the seal member 16 over-molded to/upon the first or upper endcap 14a.

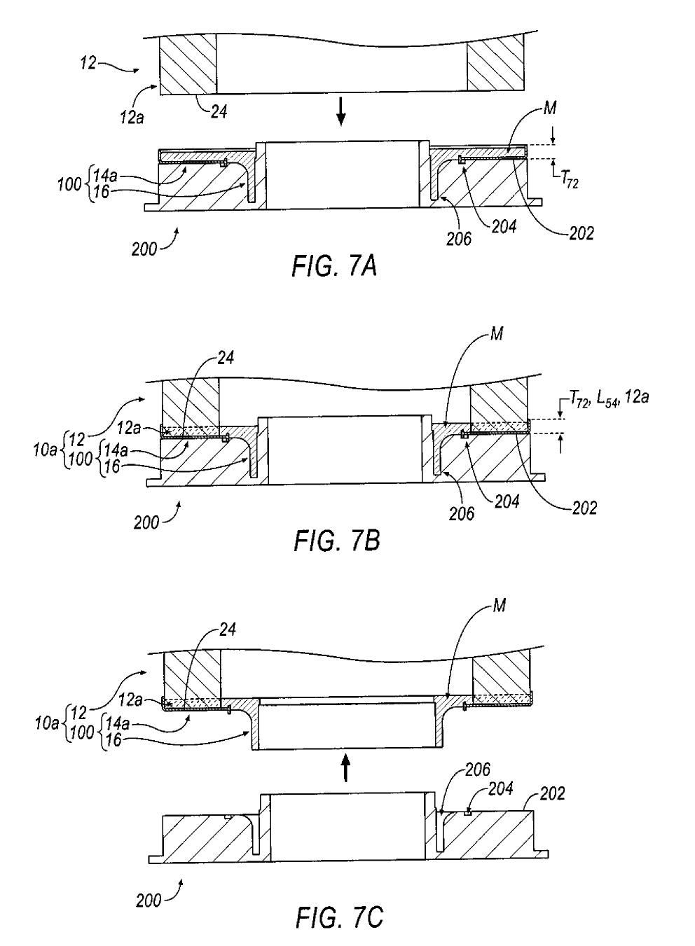

Further, as will be described in the following disclosure, the second or lower portion 56b of the inner circumferential lip 56 may form barb or tang that extends into the seal member 16 (as shown in, e.g., FIGS. 1A, 1B, 6C and 7A-7C). After the seal member 16 is formed (see, e.g., FIGS. 6C-7C) over the first or upper endcap 14a, the barb or tang 56b may engage the seal member 16 as a result of direct, physical contact of the barb or tang 56b with the seal member 16. Accordingly, upon the seal member 16 curing (i.e., transitioning from a substantially liquid or semi-solid state to a substantially solid state), the seal member 16 may not only said to be chemically bonded with the first or upper endcap 14a, but, also, the seal member 16 may be said to be frictionally connected to the first or upper endcap 14a as a result of the physical connection of the barb or tang 56b extending into the seal member 16.

Accordingly, unlike the connection of top surface 40 of the body 34 of the second or lower endcap 14b to the filter media 12 with an attaching material, A, such as, for example, a potting compound or adhesive, the bottom surface 60 of the body 52 of the first or upper endcap 14a may be connected to the filter media 12 during the formation (e.g., over-molding) of the seal member 16. As a result, the use of an attaching material, A, such as, for example, a potting compound or adhesive to connect the first or upper endcap 14a with the filter media 12 may be obviated because the upper endcap 14a may exploit and take advantage of the tacky, non-hardened, liquid, semi-solid or molten state of material, M (see, e.g., FIGS. 5B-6B), comprising the seal member 16 such that the material, M, forming the seal member 16 may be utilized to attach the first or upper endcap 14a to the filter media 12 (see, e.g., FIGS. 6A-6B).

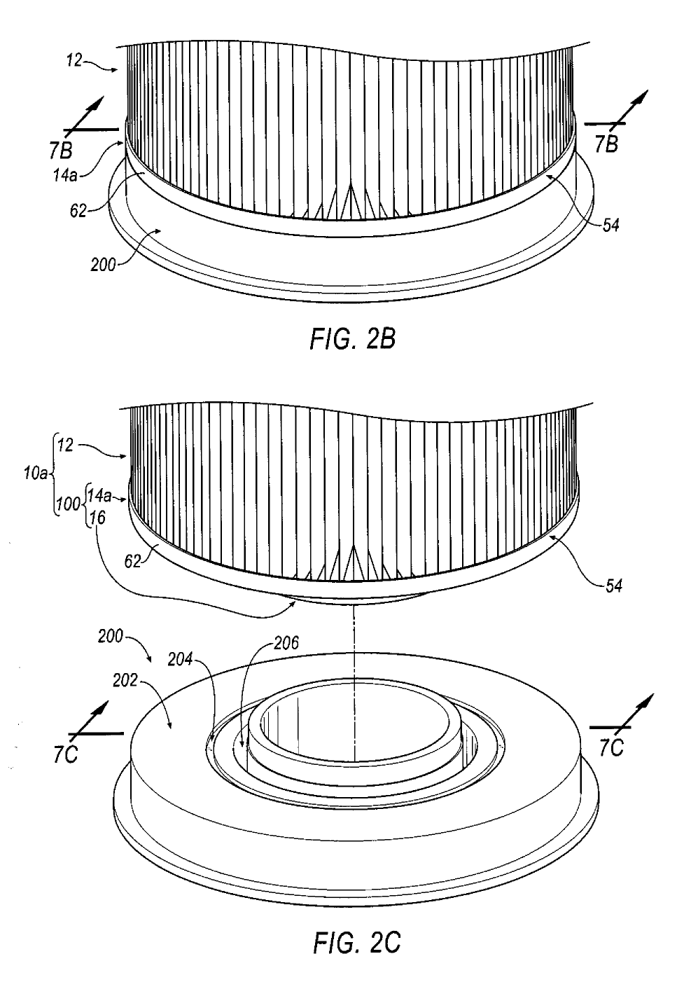

Referring to FIGS. 1A-1B and 4A, the seal member 16 may include a body 72 connected to a circumferential lip 74. The body 72 includes a top surface 76, a bottom surface 78 and an outer side surface 80 connecting the top surface 76 to the bottom surface 78. The circumferential lip 74 includes an outer surface 82 and an inner surface 84.

The top surface 76 includes a female portion or recess 86. The female portion or recess 86 may substantially correspond to the shape of and receive the barb or tang 56b of the inner circumferential lip 56 of the first or upper endcap 14a.

Referring to FIG. 4A, a first portion 76a of the top surface 76 of the body 72 of the seal member 16 may be disposed adjacent the bottom surface 60 of the body 52 of the first or upper endcap 14a. A remaining or second portion 76b of the top surface 76 of the body 72 of the seal member 16 is not disposed adjacent any portion of the first or upper endcap 14a (as seen in, e.g., FIGS. 1A-1B), but, rather, is exposed to atmosphere. The second portion 76b of the top surface 76 of the body 72 of the seal member 16 is proximate to and extends away from the first portion 76a and tapers arcuately to form the outer surface 82 of the circumferential lip 74 of the seal member 16. Referring to FIGS. 1A-1B, the outer side surface 80 of the body 72 of the seal member 16 may be disposed adjacent to the inner surface 64 of the outer circumferential lip 54 of the first or upper endcap 14a.

The inner surface 84 of the circumferential lip 74 of the seal member 16 forms a passage 88. The passage 88 formed by the inner surface 84 of the circumferential lip 74 of the seal member 16 is in fluid communication with the passage 28 formed by the inner surface 22 of the body 18 by way of the first or upper opening 30.

Referring to FIGS. 1A-1B and 4A-4B, the inner surface 84 of the of the circumferential lip 74 of the seal member 16 may include a first radial surface portion 84a, a second radial surface portion 84b and an axial ledge surface portion 84c connecting the first radial surface portion 84a to the second radial surface portion 84b. The first radial surface portion 84a of the inner surface 84 forms the passage 88 of the circumferential lip 74 of the seal member 16 to include a first diameter, D₈₈₋₁. The second radial surface portion 84b of the inner surface 84 forms the passage 88 of the circumferential lip 74 of the seal member 16 to include a second diameter, D₈₈₋₂. The second diameter, D₈₈₋₂, of the passage 88 of the circumferential lip 74 of the seal member 16 is approximately the same as, but slightly less than the first diameter, D₈₈₋₁, of the passage 88 of the circumferential lip 74 of the seal member 16.

The second diameter, D₈₈₋₂, of the passage 88 formed by the second radial surface portion 84b of the inner surface 84 of the circumferential lip 74 of the seal member 16 may be approximately equal to be less than a member, SP (see, e.g., FIG. 4A), that is to be inserted through the passage 88 formed by the inner surface 84 of the circumferential lip 74 of the seal member 16. In an implementation, the member, SP, may include a standpipe; accordingly, the seal member 16 may be referred to as a “standpipe seal.”

Referring to FIG. 4A, the body 72 of the seal member 16 may include a thickness, T₇₂. The thickness, T₇₂, may extend between the top surface 76 and the bottom surface 78 of the seal member 16. The thickness, T₇₂, of the body 72 of the seal member 16 may be approximately equal to but slightly less than a length, L₅₄ (see, e.g., FIG. 3A), of the outer circumferential lip 54 of the first or upper endcap 14a.

Referring to FIGS. 1A-1B, a portion 12a of the body 18 of the filter media 12 may extend into at least a portion of, or, substantially all of the thickness, T₇₂, of the body 72 of the seal member 16. The portion 12a of the body 18 of the filter media 12 may include a portion, L_{12A} (see, e.g., FIG. 1B), of a length, L₁₂ (see, e.g., FIG. 1B), of the body 18 of the filter media 12; accordingly the portion, L_{12A}, of the length, L₁₂, of the body 18 of the filter media 12 may be approximately equal to the thickness, T₇₂, of the body 72 of the seal member 16. The portion, L_{12A}, of the length, L₁₂, of the body 18 of the filter media 12 is approximately equal to about the length, L₅₄, of the outer circumferential lip 54 of the first or upper endcap 14a. Referring to FIGS. 7B-7C, the portion 12a of the body of the filer media 12 may be extended into the body 72 of the seal member 16 prior to curing (i.e., transitioning from a substantially liquid state to a substantially solid state) of the material, M, that forms the seal member 16.

Referring to FIGS. 2A and 5, a mold tool component is shown generally at 200 in accordance with an exemplary embodiment of the invention. Referring to FIG. 5, the mold tool component 200 includes a surface 202 having a first surface portion 202a and a second surface portion 202b.

As seen in FIG. 6A, the first surface portion 202a may provide a support surface for supporting one or more surfaces of the first or upper endcap 14a that is/are disposed adjacent the first surface portion 202a. The one or more surfaces of the first or upper endcap 14a that is/are disposed adjacent the first surface portion 202a may include the top surface 58 of the body 52 and one or more of the outer surface 66, the inner surface 68 and the top surface portion 70 of the first or upper portion 56a of the inner circumferential lip 56.

Referring to FIG. 6B, the second surface portion 202b may provide a surface that receives material, M, for forming one or more surface portions of the seal member 16. The one or more surface portions of the seal member 16 that are formed by the second surface portion 202b may include the second portion 76b of the top surface 76 of the body 72 of the seal member 16 and the outer surface 82 and the inner surface 84 (including the first radial surface portion 84a, the second radial surface portion 84b and the axial ledge surface portion 84c) of the circumferential lip 74 of the seal member 16.

Referring to FIG. 6A, the remaining surface portions of the seal member 16 that are not formed by the second surface portion 202b may be formed by one or more surface portions of the first or upper endcap 14a. The remaining surface portions of the seal member 16 formed by one or more surface portions of the first or upper endcap 14a may include the first portion 76a of the top surface 76 of the body 72 of the seal member 16 (disposed adjacent the bottom surface 60 of the body 52 of the first or upper endcap 14a) and the outer side surface 80 of the body 72 of the seal member 16 (disposed adjacent to the inner surface 64 of the outer circumferential lip 54 of the first or upper endcap 14a). Accordingly, the bottom surface 60 of the body 52 of the first or upper endcap 14a and the inner surface 64 of the outer circumferential lip 54 of the first or upper endcap 14a may cooperate with the second surface portion 202b of the mold tool component 200 in order to form or provide a molding surface for receiving the material, M, and that forms the seal member 16.

Referring to FIGS. 5 and 6A, the first surface portion 202a may form a female portion or recess 204. As described above, the female portion or recess 204 corresponds to the male portion or locating rib 56a of the first or upper endcap 14a for assisting in the positioning (e.g., a central positioning) of the first or upper endcap 14a upon the mold tool component 200 in order to, for example, ensure accurate repeatability of a formation of a plurality of sub-assemblies 100 including a seal member 16 over-molded with that of an first or upper endcap 14a.

The second surface portion 202b may form a cavity 206. The cavity 206 includes a surface geometry (e.g., a circumferential or ring-shaped trough including a wall portion that flares or tapers radially-outwardly) for receiving a volume of the material, M, for forming the one or more surface portions of the seal member 16 including, for example, the second portion 76b of the top surface 76 of the body 72 of the seal member 16 and the outer surface 82 and the inner surface 84 (including the first radial surface portion 84a, the second radial surface portion 84b and the axial ledge surface portion 84c) of the circumferential lip 74 of the seal member 16.

Referring to FIGS. 6A-6C, a method for forming the sub-assembly 100 is described in accordance with an embodiment of the invention. Referring also to FIGS. 6A-7C, a method for forming a portion 10a of the filter assembly 10 including the sub-assembly 100 and the filer media 12 is described in accordance with an embodiment of the invention.

As seen in FIG. 6A, the first or upper endcap 14a may be disposed adjacent the first surface portion 202a of the surface 202 of the mold tool component 200. The disposing of the first or upper endcap 14a adjacent the first surface portion 202a of the surface 202 of the mold tool component 200 may include the registering of the male portion or locating rib 56a of the first or upper endcap 14a within the female portion or recess 204 of the first surface portion 202a of the surface 202 of the mold tool component 200.

Referring to FIG. 6B, after arranging the first or upper endcap 14a adjacent the first surface portion 202a of the mold tool component 200, an extruder 208 may deposit an amount of the material, M, upon the second surface portion 202b of the mold tool component 200 and the bottom surface 60 of the body 52 of the first or upper endcap 14a and the inner surface 64 of the outer circumferential lip 54 of the first or upper endcap 14a. The extruder 208 may be in communication with a supply, hopper or reservoir 210 that contains the material, M. The material, M, may include any desirable material, such as for example, a poly material.

The extruder 208 may be in communication with a controller 212 for de/actuating a valve (not shown) associated with the extruder 208 in order to permit or deny flow of the material, M, from the reservoir 210, through the extruder 208 and upon the second surface portion 202b of the mold tool component 200 and the bottom surface 60 of the body 52 of the first or upper endcap 14a and the inner surface 64 of the outer circumferential lip 54 of the first or upper endcap 14a.

As seen in FIG. 6B, the material, M, is deposited in a substantially liquid or semi-solid form. Upon flowing the material, M, the material, M conforms to a molding surface geometry defined by, for example, the second surface portion 202b of the mold tool component 200 and the bottom surface 60 of the body 52 of the first or upper endcap 14a and the inner surface 64 of the outer circumferential lip 54 of the first or upper endcap 14a.

Referring to FIG. 6C, once a volume of the material, M, has been deposited upon the second surface portion 202b of the mold tool component 200 and the bottom surface 60 of the body 52 of the first or upper endcap 14a and the inner surface 64 of the outer circumferential lip 54 of the first or upper endcap 14a, the flowing of the material, M, from the extruder 208 may cease. The ceasing of the flowing of the material, M, from the extruder 208 may be conducted in response to a signal sent from the controller 212 to the extruder 208.

Referring to FIG. 6C, upon solidification of the material, M (as a result of, e.g., curing of the material, M), the seal member 16 may be formed and may chemically bond to the first or upper endcap 14a in order to form the sub-assembly 100. The sub-assembly 100 may be removed from the mold tool component 200, if desired, and subsequently attached to filter media, such as for example, the filter media 12, by way of, for example, an adhesive, potting compound or the like. However, the liquid or semi-solid state of the material, M, may be advantageously exploited in order to utilize the material, M, that forms the seal member 16 as an attachment medium for joining the first or upper endcap 14a to the filter media 12 for forming the portion 10a of the filter assembly 10.

Prior to, during or after the depositing of the material, M, as described at FIGS. 6A-6C, the filter media 12 may be arranged upon one or more of the first or upper endcap 14a and the material, M. Referring to FIGS. 7A-7B, in an embodiment, prior to curing of the material, M, the portion 12a of the body 18 of the filter media 12 may be arranged upon and inserted into the thickness, T₇₂, of the material, M, that forms the seal member 16.

Upon inserting the filter media 12 into the thickness, T₇₂, of the material, M, the material, M, may be permitted to flow into an impregnate the portion 12a of the body 18 of the filter media 12. Subsequently, the material, M, may cure, and, as a result, the material, M, may form the seal member 16 while also being utilized to chemically bond the filter media 12 as well as to the first or upper endcap 14a. Upon the material, M, being cured, the filter media 12 along with the seal member 16 that has been integrally formed with (e.g. over-molded or molded-over) the first or upper endcap 14a are removed (see, e.g., FIG. 7C) from the mold tool component 200.

The connection of the filter media 12, the first or upper endcap 14a and the seal member 16 described at FIGS. 7A-7C may result in the formation of a portion 10a of the filter assembly 10. Upon subsequently attaching the second or lower endcap 14b to the portion 10a, the filter assembly 10 may be said to be formed. However, in an embodiment, the second or lower endcap 14b may be attached to the filter media 12 prior to attaching the filter media 12 to the sub-assembly 100; accordingly if the second or lower endcap 14b is previously attached to the filter media 12, upon attaching the filter media 12 to the sub-assembly 100, the filter assembly 10 may be said to be formed.

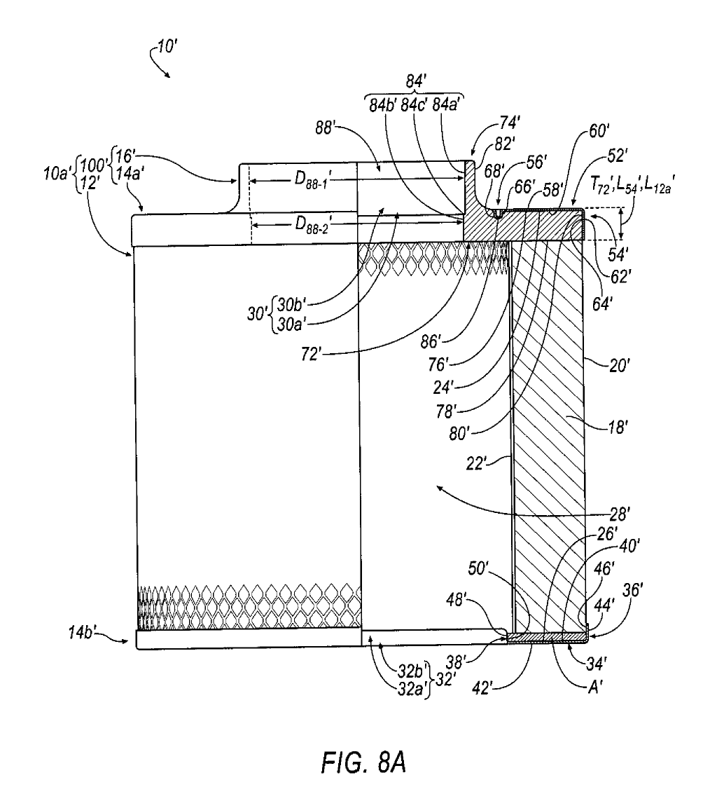

Referring to FIGS. 8A-8B, a filter assembly is shown generally at 10′ in accordance with an exemplary embodiment of the invention. The filter assembly 10′ includes filter media 12′, a first or upper endcap cap 14a′, a second a lower endcap 14b′ and a seal member 16′.

As will be explained in the following disclosure, the first or upper endcap cap 14a′ and the seal member 16′ may form a sub-assembly 100′ (see, e.g., FIGS. 8B, 13C and 14A) of the filter assembly 10′. Subsequent attachment of the filter media 12′ to the sub-assembly 100′ may form a portion 10a′ of the filter assembly 10′ (see, e.g., FIGS. 8B, 9B-9C, 14A-14C). Referring to FIG. 8B, the second or lower endcap 14b′ may be attached to the portion 10a′ (by way of, e.g., attaching material, A′, such as, for example, an adhesive, potting compound, or the like) for forming the filter assembly 10′.

Referring to FIGS. 8A-8B, the filter media 12′ may include a body 18′. The body 18′ includes an outer surface 20′, an inner surface 22′, a first or upper end surface 24′ and a second or lower end surface 26′. The body 18′ may include any desirable geometry or shape such as, for example, a ring shape, a cylindrical shape, a tube shape or the like.

The inner surface 22′ forms a passage 28′ extending through the body 18′. The first or upper end surface 24′ forms a first or upper opening 30a′ in the body 18′. The second or lower end surface 26′ forms a second or lower opening 32a′ in the body 18′. The first or upper opening 30a′ and the second or lower opening 32a′ each provide access to the passage 28′.

The second or lower endcap 14b′ may include a body 34′ connected to an outer circumferential lip 36′ and an inner circumferential lip 38′. The body 34′ includes a top surface 40′ and a bottom surface 42′. The outer circumferential lip 36′ includes an outer surface 44′ and an inner surface 46′. The inner circumferential lip 38′ includes an outer surface 48′ and an inner surface 50′. The outer surface 48′ of the inner circumferential lip 38′ of the second or lower endcap 14b′ forms an opening 32b′.

The second or lower opening 32a′ in the body 18′ of filter media 12′ and the opening 32b′ of the second or lower endcap 14b′ may be one-in-the same in that both openings 32a′, 32b′ provide access to the passage 28′ extending through the body 18′ of filter media 12′. Accordingly, the openings 32a′, 32b′ may be collectively referred to as a lower opening 32′ (see, e.g., FIG. 8A).

The top surface 40′ of the body 34′ of the second or lower endcap 14b′ may be disposed substantially adjacent and connected to the second or lower end surface 26′ of the filter media 12′. The top surface 40′ of the body 34′ of the second or lower endcap 14b′ may be connected to the second or lower end surface 26′ of the filter media 12′ with any desirable attaching material, A′, such as, for example, an adhesive, potting compound or the like.

The inner surface 46′ of the outer circumferential lip 36′ of the second or lower endcap 14b′ may be in a spaced-apart relationship with the outer surface 20′ of the filter media 12′. Alternatively, the inner surface 46′ of the outer circumferential lip 36′ of the second or lower endcap 14b′ may be in an adjacent relationship with the outer surface 20′ of the filter media 12′.

The inner surface 50′ of the inner circumferential lip 38′ of the second or lower endcap 14b′ may be in a spaced-apart relationship with the inner surface 22′ of the filter media 12′. Alternatively, the inner surface 50′ of the inner circumferential lip 38′ of the second or lower endcap 14b′ may be in an adjacent relationship with the inner surface 22′ of the filter media 12′.

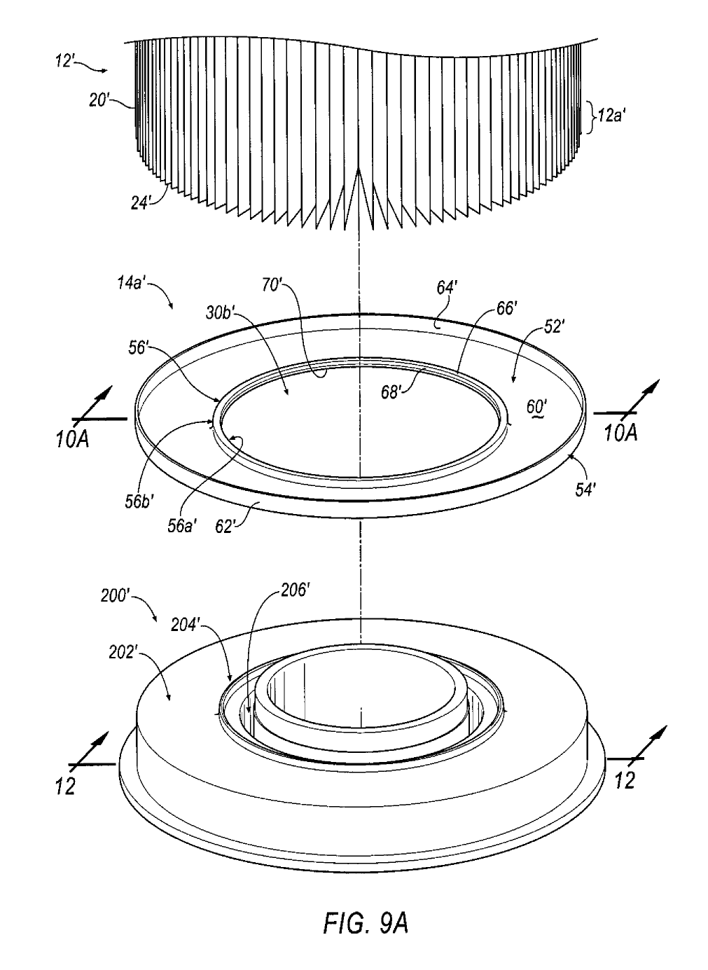

Referring to FIGS. 8A-8B and 10A, the first or upper endcap 14a′ is shown. FIGS. 8A-8B may be described as being a “right-side-up” view of the first or upper endcap 14a′ whereas FIG. 10A may be described as being an “up-side-down” view of the first or upper endcap 14a′. Accordingly, when words such as, for example, “upper,” “top” or “bottom” are used to describe features of the first or upper endcap 14a′, the “right-side-up” view of FIGS. 8A-8B is utilized as a frame of reference for describing features of the first or upper endcap 14a′; however, when FIG. 10A is referenced, the use of the words “upper,” “top” and “bottom” (from describing FIGS. 8A-8B) are maintained for consistency. Thus, based on the foregoing, it is reminded that the nomenclature used herein is simply for convenience and the terms (e.g., “upper,” “top,” “bottom” and the like) used to describe the invention should be given the broadest meaning by one of ordinary skill in the art.

Referring to FIGS. 8A-8B and 10A, the first or upper endcap 14a′ may include a body 52′ connected to an outer circumferential lip 54′ and an inner circumferential lip 56′. The body 52′ includes a top surface 58′ and a bottom surface 60′. The outer circumferential lip 54′ includes an outer surface 62′ and an inner surface 64′.

Referring also to FIG. 10B, the inner circumferential lip 56′ includes an inner surface 66′ and an outer surface 68′. The outer surface 68′ of the inner circumferential lip 54′ of the first or upper endcap 14a′ forms an upper opening 30b′.

The first or upper opening 30a′ in the body 18′ of the filter media 12′ and the opening 30b′ of the first or upper endcap 14a′ may be one-in-the same in that both openings 30a′, 30b′ provide access to the passage 28′ extending through the body 18′. Accordingly, the openings 30a′, 30b′ may be collectively referred to as an upper opening 30′ (see, e.g., FIG. 8A).

The inner surface 64′ of the outer circumferential lip 54′ of the first or upper endcap 14a′ may be in a spaced-apart relationship with the outer surface 20′ of the filter media 12′. Alternatively, the inner surface 64′ of the outer circumferential lip 54′ of the first or upper endcap 14a′ may be in an adjacent relationship with the outer surface 20′ of the filter media 12′.

The inner surface 66′ of the inner circumferential lip 56′ of the first or upper endcap 14a′ may be in a spaced-apart relationship with the inner surface 22′ of the filter media 12′. Alternatively, the inner surface 66′ of the inner circumferential lip 56′ of the first or upper endcap 14a′ may be in an adjacent relationship with the inner surface 22′ of the filter media 12′.

Referring to FIG. 10B, the inner circumferential lip 56′ includes a U-shaped body portion 56a′ that is integrally connected with the body 52′ of the first or upper endcap 14a′. The inner surface 66′ of the circumferential lip 56′ is connected to and extends away from the bottom surface 60′ of the body 52′ of the first or upper endcap 14a′. The U-shaped body portion 56a′ of the inner circumferential lip 56′ generally defines a female portion, groove or recess 56b′. The female portion or recess 56b′ defines a valley or top surface portion 70′. The valley or top surface portion 70′ is connected to and extends away from and beyond the top surface 58′ of the body 52′ of the first or upper endcap 14a′.

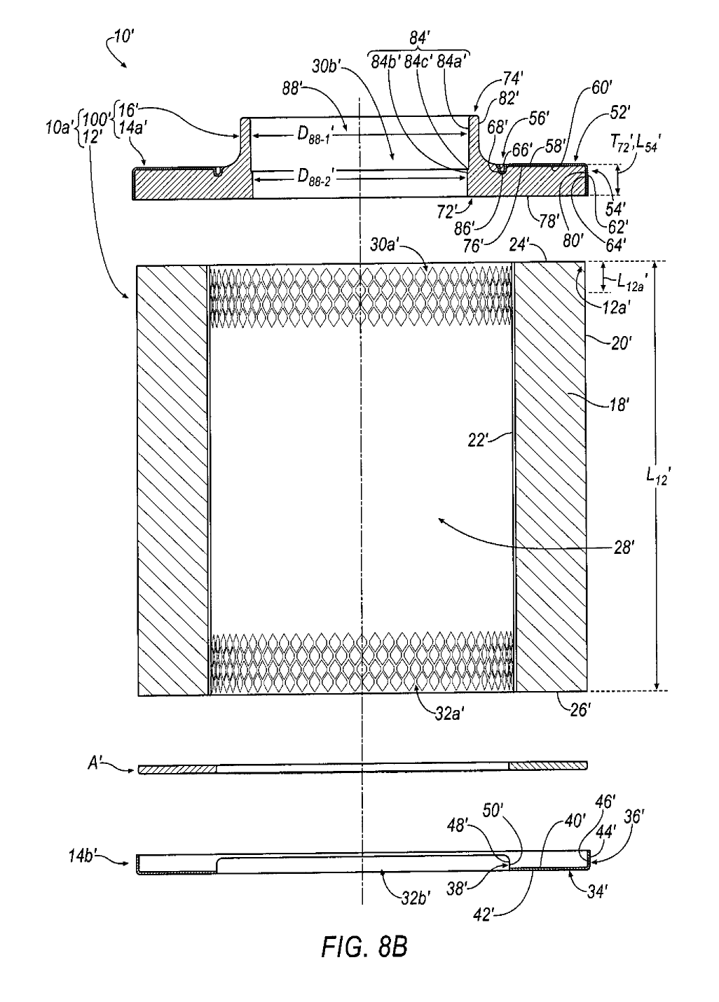

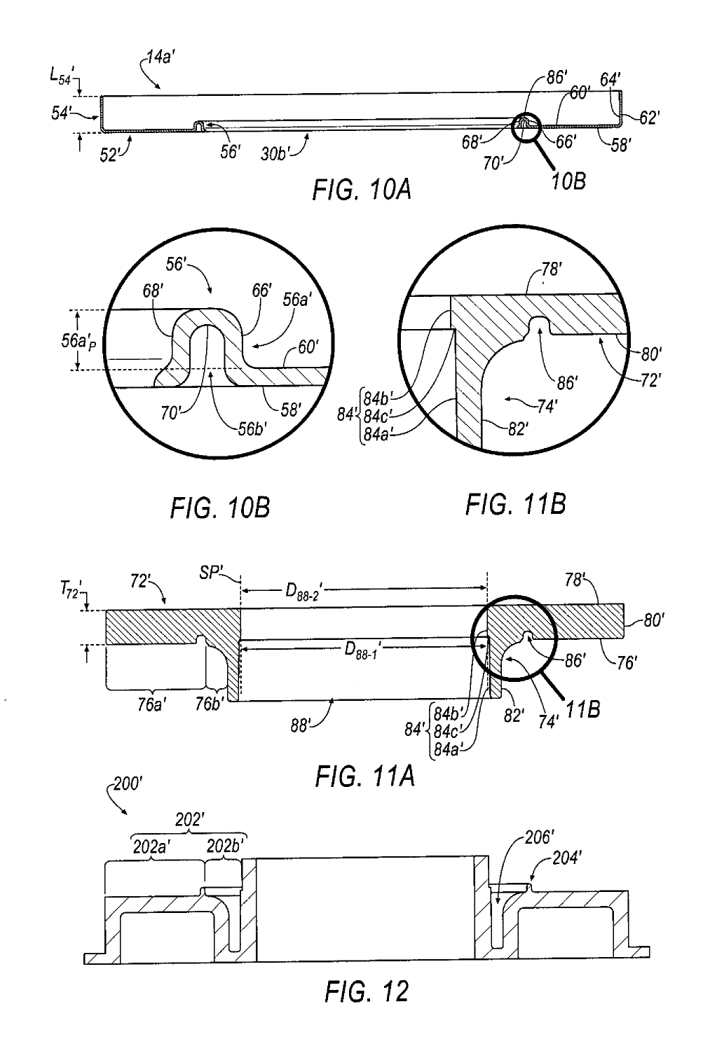

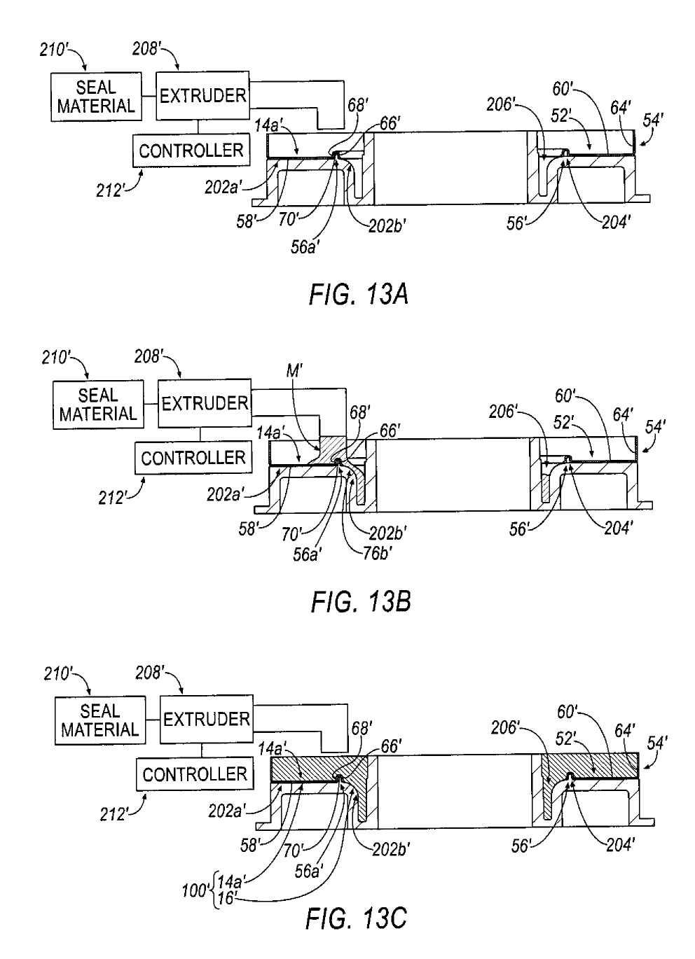

As will be described in the following disclosure at FIG. 13A, the female portion or recess 56b′ of the inner circumferential lip 56′ interfaces with a mold tool component (see, e.g., 200′ of FIGS. 9A-9C, 12). The female portion or recess 56b′ interfaces with a male portion or locating rib (see, e.g., 204′) formed by the mold tool component 200′. Accordingly, upon arranging the female portion or recess 56b′ formed by the inner circumferential lip 56′ upon a male portion or locating rib 204′ formed by the mold tool component 200′, the first or upper endcap 14a′ may be controllably-positioned (e.g., centrally positioned) upon the mold tool component 200′ in order to, for example, ensure accurate repeatability of a formation (e.g., an over-molding) of plurality of sub-assemblies 100′ including the seal member 16′ over-molded to/upon the first or upper endcap 14a′.

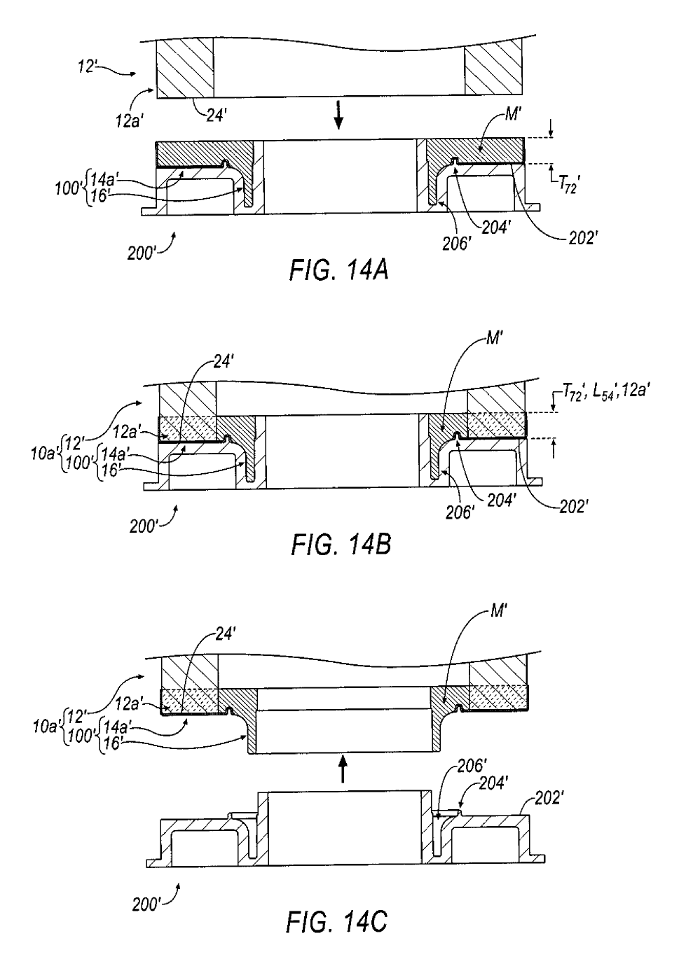

Further, as seen in FIG. 10B, a portion 56a′_{P} of the U-shaped body portion 56a′ that extends away from and beyond the bottom surface 60′ of the body 52′ of the first or upper endcap 14a′ may form barb or tang that extends into the seal member 16′ (as shown in, e.g., FIGS. 8A, 8B, 13C and 14A-14C). After the seal member 16′ is formed (see, e.g., FIGS. 13C-14C) over the first or upper endcap 14a′, the barb or tang 56a′_{P} may engage the seal member 16′ as a result of direct, physical contact of the barb or tang 56a′_{P} with the seal member 16′. Accordingly, upon the seal member 16′ curing (i.e., transitioning from a substantially liquid or semi-solid state to a substantially solid state), the seal member 16′ may not only said to be chemically bonded with the first or upper endcap 14a′, but, also, the seal member 16′ may be said to be frictionally connected to the first or upper endcap 14a′ as a result of the physical connection of the barb or tang 56a′_{P} extending into the seal member 16′.

Accordingly, unlike the connection of top surface 40′ of the body 34′ of the second or lower endcap 14b′ to the filter media 12′ with an attaching material, A′, such as, for example, a potting compound or adhesive, the bottom surface 60′ of the body 52′ of the first or upper endcap 14a′ may be connected to the filter media 12′ during the formation (e.g., over-molding) of the seal member 16′. As a result, the use of an attaching material, A′, such as, for example, a potting compound or adhesive to connect the first or upper endcap 14a′ with the filter media 12′ may be obviated because the upper endcap 14a′ may exploit and take advantage of the tacky, non-hardened, liquid, semi-solid or molten state of material, M′ (see, e.g., FIGS. 12B-13B), comprising the seal member 16′ such that the material, M′, forming the seal member 16′ may be utilized to attach the first or upper endcap 14a′ to the filter media 12′ (see, e.g., FIGS. 13A-13B).

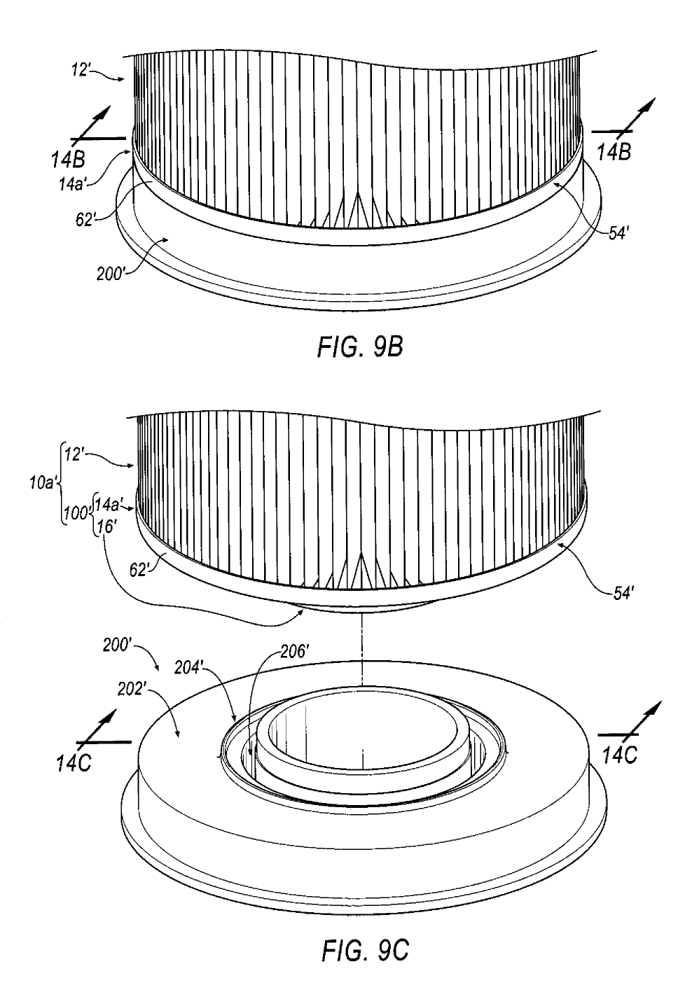

Referring to FIGS. 8A-8B and 11A, the seal member 16′ may include a body 72′ connected to a circumferential lip 74′. The body 72′ includes a top surface 76′, a bottom surface 78′ and an outer side surface 80′ connecting the top surface 76′ to the bottom surface 78′. The circumferential lip 74′ includes an outer surface 82′ and an inner surface 84′.

The top surface 76′ includes a female portion or recess 86′. The female portion or recess 86′ may substantially correspond to the shape of and receive the barb or tang 56a′_{P} formed by the portion 56a′_{P} of the U-shaped body portion 56a′ of the inner circumferential lip 56 of the first or upper endcap 14a that extends away from and beyond the bottom surface 60′ of the body 52′ of the first or upper endcap 14a′.

Referring to FIG. 11A, a first portion 76a′ of the top surface 76′ of the body 72′ of the seal member 16′ may be disposed adjacent the bottom surface 60′ of the body 52′ of the first or upper endcap 14a′. A remaining or second portion 76b′ of the top surface 76′ of the body 72′ of the seal member 16′ is not disposed adjacent any portion of the first or upper endcap 14a′ (as seen in, e.g., FIGS. 8A-8B), but, rather, is exposed to atmosphere. The second portion 76b′ of the top surface 76′ of the body 72′ of the seal member 16′ is proximate to and extends away from the first portion 76a′ and tapers arcuately to form the outer surface 82′ of the circumferential lip 74′ of the seal member 16′. Referring to FIGS. 8A-8B, the outer side surface 80′ of the body 72′ of the seal member 16′ may be disposed adjacent to the inner surface 64′ of the outer circumferential lip 54′ of the first or upper endcap 14a′.

The inner surface 84′ of the circumferential lip 74′ of the seal member 16′ forms a passage 88′. The passage 88′ formed by the inner surface 84′ of the circumferential lip 74′ of the seal member 16′ is in fluid communication with the passage 28′ formed by the inner surface 22′ of the body 18′ by way of the first or upper opening 30′.

Referring to FIGS. 8A-8B and 11A-11B, the inner surface 84′ of the circumferential lip 74′ of the seal member 16′ may include a first radial surface portion 84a′, a second radial surface portion 84b′ and an axial ledge surface portion 84c′ connecting the first radial surface portion 84a′ to the second radial surface portion 84b′. The first radial surface portion 84a′ of the inner surface 84′ forms the passage 88′ of the circumferential lip 74′ of the seal member 16′ to include a first diameter, D₈₈₋₁′. The second radial surface portion 84b′ of the inner surface 84′ forms the passage 88′ of the circumferential lip 74′ of the seal member 16′ to include a second diameter, D₈₈₋₂′. The second diameter, D₈₈₋₂′, of the passage 88′ of the circumferential lip 74′ of the seal member 16′ is approximately the same as, but slightly less than the first diameter, D₈₈₋₁′, of the passage 88′ of the circumferential lip 74′ of the seal member 16′.

The second diameter, D₈₈₋₂′, of the passage 88′ formed by the second radial surface portion 84b′ of the inner surface 84′ of the circumferential lip 74′ of the seal member 16′ may be approximately equal to but less than a member, SP′ (see, e.g., FIG. 11A), that is to be inserted through the passage 88′ formed by the inner surface 84′ of the circumferential lip 74′ of the seal member 16′. In an implementation, the member, SP′, may include a standpipe; accordingly, the seal member 16′ may be referred to as a “standpipe seal.”

Referring to FIG. 11A, the body 72′ of the seal member 16′ may include a thickness, T₇₂′. The thickness, T₇₂′, may extend between the top surface 76′ and the bottom surface 78′ of the seal member 16′. The thickness, T₇₂′, of the body 72′ of the seal member 16′ may be approximately equal to but slightly less than a length, L₅₄′ (see, e.g., FIG. 10A), of the outer circumferential lip 54′ of the first or upper endcap 14a′.

Referring to FIGS. 8A-8B, a portion 12a′ of the body 18′ of the filter media 12′ may extend into at least a portion of, or, substantially all of the thickness, T₇₂′, of the body 72′ of the seal member 16′. The portion 12a′ of the body 18′ of the filter media 12′ may include a portion, L_{12A}′ (see, e.g., FIG. 8B), of a length, L₁₂′ (see, e.g., FIG. 8B), of the body 18′ of the filter media 12′; accordingly the portion, L_{12A}′, of the length, L₁₂′, of the body 18′ of the filter media 12′ may be approximately equal to the thickness, T₇₂′, of the body 72′ of the seal member 16′. The portion, L_{12A}′, of the length, L₁₂′, of the body 18′ of the filter media 12′ is approximately equal to about the length, L₅₄′, of the outer circumferential lip 54′ of the first or upper endcap 14a′. Referring to FIGS. 14B-14C, the portion 12a′ of the body of the filer media 12′ may be extended into the body 72′ of the seal member 16′ prior to curing (i.e., transitioning from a substantially liquid state to a substantially solid state) of the material, M′, that forms the seal member 16′.

Referring to FIGS. 9A and 12, a mold tool component is shown generally at 200′ in accordance with an exemplary embodiment of the invention. Referring to FIG. 12, the mold tool component 200′ includes a surface 202′ having a first surface portion 202a′ and a second surface portion 202b′.

As seen in FIG. 13A, the first surface portion 202a′ may provide a support surface for supporting one or more surfaces of the first or upper endcap 14a′ that is/are disposed adjacent the first surface portion 202a′. The one or more surfaces of the first or upper endcap 14a′ that is/are disposed adjacent the first surface portion 202a′ may include the top surface 58′ of the body 52′ and the valley or top surface portion 70′ defined by the female portion or recess 56b′ of the inner circumferential lip 56.

Referring to FIG. 13B, the second surface portion 202b′ may provide a surface that receives material, M′, for forming one or more surface portions of the seal member 16′. The one or more surface portions of the seal member 16′ that are formed by the second surface portion 2026′ may include the second portion 76b′ of the top surface 76′ of the body 72′ of the seal member 16′ and the outer surface 82′ and the inner surface 84′ (including the first radial surface portion 84a′, the second radial surface portion 84b′ and the axial ledge surface portion 84c′) of the circumferential lip 74′ of the seal member 16′.

Referring to FIG. 13A, the remaining surface portions of the seal member 16′ that are not formed by the second surface portion 202b′ may be formed by one or more surface portions of the first or upper endcap 14a′. The remaining surface portions of the seal member 16′ formed by one or more surface portions of the first or upper endcap 14a′ may include the first portion 76a′ of the top surface 76′ of the body 72′ of the seal member 16′ (disposed adjacent the bottom surface 60′ of the body 52′ of the first or upper endcap 14a′) and the outer side surface 80′ of the body 72′ of the seal member 16′ (disposed adjacent to the inner surface 64′ of the outer circumferential lip 54′ of the first or upper endcap 14a′). Accordingly, the bottom surface 60′ of the body 52′ of the first or upper endcap 14a′ and the inner surface 64′ of the outer circumferential lip 54′ of the first or upper endcap 14a′ may cooperate with the second surface portion 202b′ of the mold tool component 200′ in order to form or provide a molding surface for receiving the material, M′, and that forms the seal member 16′.

Referring to FIGS. 12 and 13A, the first surface portion 202a′ may form a male portion or locating rib 204′. As described above, the male portion or locating rib 204′ corresponds to the female portion or recess 56b′ of the first or upper endcap 14a′ for assisting in the positioning (e.g., a central positioning) of the first or upper endcap 14a′ upon the mold tool component 200′ in order to, for example, ensure accurate repeatability of a formation of a plurality of sub-assemblies 100′ including a seal member 16′ over-molded with that of an first or upper endcap 14a′.

The second surface portion 202b′ may form a cavity 206′. The cavity 206′ includes a surface geometry (e.g., a circumferential or ring-shaped trough including a wall portion that flares or tapers radially-outwardly) for receiving a volume of the material, M′, for forming the one or more surface portions of the seal member 16′ including, for example, the second portion 76b′ of the top surface 76′ of the body 72′ of the seal member 16′ and the outer surface 82′ and the inner surface 84′ (including the first radial surface portion 84a′, the second radial surface portion 84b′ and the axial ledge surface portion 84c′) of the circumferential lip 74′ of the seal member 16′.

Referring to FIGS. 13A-13C, a method for forming the sub-assembly 100′ is described in accordance with an embodiment of the invention. Referring also to FIGS. 13A-14C, a method for forming a portion 10a′ of the filter assembly 10′ including the sub-assembly 100′ and the filer media 12′ is described in accordance with an embodiment of the invention.

As seen in FIG. 13A, the first or upper endcap 14a′ may be disposed adjacent the first surface portion 202a′ of the surface 202′ of the mold tool component 200′. The disposing of the first or upper endcap 14a′ adjacent the first surface portion 202a′ of the surface 202′ of the mold tool component 200′ may include the registering of the female portion or recess 56b′ of the first or upper endcap 14a′ upon the male portion or locating rib 204′ of the first surface portion 202a′ of the surface 202′ of the mold tool component 200′.

Referring to FIG. 13B, after arranging the first or upper endcap 14a′ adjacent the first surface portion 202a′ of the mold tool component 200′, an extruder 208′ may deposit an amount of the material, M′, upon the second surface portion 202b′ of the mold tool component 200′ and the bottom surface 60′ of the body 52′ of the first or upper endcap 14a′ and the inner surface 64′ of the outer circumferential lip 54′ of the first or upper endcap 14a′. The extruder 208′ may be in communication with a supply, hopper or reservoir 210′ that contains the material, M′. The material, M′, may include any desirable material, such as for example, a poly material.

The extruder 208′ may be in communication with a controller 212′ for de/actuating a valve (not shown) associated with the extruder 208′ in order to permit or deny flow of the material, M′, from the reservoir 210′, through the extruder 208′ and upon the second surface portion 202b′ of the mold tool component 200′ and the bottom surface 60′ of the body 52′ of the first or upper endcap 14a′ and the inner surface 64′ of the outer circumferential lip 54′ of the first or upper endcap 14a′.

As seen in FIG. 13B, the material, M′, is deposited in a substantially liquid or semi-solid form. Upon flowing the material, M′, the material, M′, conforms to a molding surface geometry defined by, for example, the second surface portion 202b′ of the mold tool component 200′ and the bottom surface 60′ of the body 52′ of the first or upper endcap 14a′ and the inner surface 64′ of the outer circumferential lip 54′ of the first or upper endcap 14a′.

Referring to FIG. 13C, once a volume of the material, M′, has been deposited upon the second surface portion 202b′ of the mold tool component 200′ and the bottom surface 60′ of the body 52′ of the first or upper endcap 14a′ and the inner surface 64′ of the outer circumferential lip 54′ of the first or upper endcap 14a′, the flowing of the material, M′, from the extruder 208′ may cease. The ceasing of the flowing of the material, M′, from the extruder 208′ may be conducted in response to a signal sent from the controller 212′ to the extruder 208′.

Referring to FIG. 13C, upon solidification of the material, M′ (as a result of, e.g., curing of the material, M′), the seal member 16′ may be formed and may chemically bond to the first or upper endcap 14a′ in order to form the sub-assembly 100′. The sub-assembly 100′ may be removed from the mold tool component 200′, if desired, and subsequently attached to filter media, such as for example, the filter media 12′, by way of, for example, an adhesive, potting compound or the like. However, the liquid or semi-solid state of the material, M′, may be advantageously exploited in order to utilize the material, M′, that forms the seal member 16′ as an attachment medium for joining the first or upper endcap 14a′ to the filter media 12′ for forming the portion 10a′ of the filter assembly 10′.

Prior to, during or after the depositing of the material, M′, as described at FIGS. 13A-13C, the filter media 12′ may be arranged upon one or more of the first or upper endcap 14a′ and the material, M′. Referring to FIGS. 14A-14B, in an embodiment, prior to curing of the material, M′, the portion 12a′ of the body 18′ of the filter media 12′ may be arranged upon and inserted into the thickness, T₇₂′, of the material, M′, that forms the seal member 16′.

Upon inserting the filter media 12′ into the thickness, T₇₂′, of the material, M′, the material, M′, may be permitted to flow into an impregnate the portion 12a′ of the body 18′ of the filter media 12′. Subsequently, the material, M′, may cure, and, as a result, the material, M′, may form the seal member 16′ while also being utilized to chemically bond to the filter media 12′ as well as to the first or upper endcap 14a′. Upon the material, M′, being cured, the filter media 12′ along with the seal member 16′ that has been integrally formed with (e.g. over-molded or molded-over) the first or upper endcap 14a′ are removed (see, e.g., FIG. 14C) from the mold tool component 200′.

The connection of the filter media 12′, the first or upper endcap 14a′ and the seal member 16′ described at FIGS. 14A-14C may result in the formation of a portion 10a′ of the filter assembly 10′. Upon subsequently attaching the second or lower endcap 14b′ to the portion 10a′, the filter assembly 10′ may be said to be formed. However, in an embodiment, the second or lower endcap 14b′ may be attached to the filter media 12′ prior to attaching the filter media 12′ to the sub-assembly 100′; accordingly if the second or lower endcap 14b′ is previously attached to the filter media 12′, upon attaching the filter media 12′ to the sub-assembly 100′, the filter assembly 10′ may be said to be formed.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A sub-assembly of a filter assembly, comprising:
an endcap including
a body,
an outer circumferential lip connected to a first end of the body, and
an inner circumferential lip body connected to a second end of the body, wherein the inner circumferential lip body defines a groove, wherein the inner circumferential lip body extends away from and beyond a bottom surface of the body of the endcap; and
a seal member connected to the endcap, wherein the seal member includes
a body, and
a circumferential lip connected to the body of the seal member, wherein the body of the seal member includes a top surface and a bottom surface, wherein the top surface of the body of the seal member includes a recess, wherein the inner circumferential lip body of the endcap is arranged within the recess of the seal member.

2. The sub-assembly according to claim 1 further comprising
means for positioning the endcap upon a mold tool component prior to utilizing the mold tool for connecting the seal member to the end cap.

3. The sub-assembly according to claim 2, wherein the means includes the groove formed by the inner circumferential lip body that interfaces with a locating rib formed by a mold surface of a mold tool component.

4. The sub-assembly according to claim 1, wherein the top surface of the body of the seal member includes
a first portion that is disposed adjacent the bottom surface of the body of the first or upper endcap and an inner surface of the outer circumferential lip, and
a second portion that directly connected to and extends away from the first portion and is not disposed adjacent any of the bottom surface of the endcap.

5. The sub-assembly according to claim 1, wherein the circumferential lip of the seal member includes
an outer surface, and
an inner surface, wherein the inner surface of the circumferential lip of the seal member forms a passage extending through the seal member.

6. The sub-assembly according to claim 5, wherein the inner surface of the circumferential lip of the seal member includes
a first radial surface portion,
a second radial surface portion, and
an axial ledge surface portion connecting the first radial surface portion to the second radial surface portion, wherein the first radial surface portion forms the passage extending through the seal member to include a first diameter, wherein the second radial surface portion forms the passage extending through the seal member to include a second diameter.

7. The sub-assembly according to claim 6, wherein the second diameter is approximately the equal to, but slightly less than the first diameter.

8. The sub-assembly according to claim 6, wherein one or both of the first and second diameters are approximately equal to a diameter of a standpipe.

9. A portion of a filter assembly, comprising:
a sub-assembly including an endcap connected to a seal-member, wherein the endcap includes a body, an outer circumferential lip connected to a first end of the body and an inner circumferential lip body connected to a second end of the body, wherein the inner circumferential lip body defines a groove, wherein the inner circumferential lip body extends away from and beyond the bottom surface of the body of the endcap, wherein the seal member includes a body and a circumferential lip connected to the body of the seal member, wherein the body of the seal member includes a top surface and a bottom surface, wherein the top surface of the body of the seal member includes a recess, wherein the inner circumferential lip body of the endcap is arranged within the recess of the seal member; and
a filter media connected to the sub-assembly, wherein the filter media includes a body extending between an upper end surface and a second or lower end surface, wherein a portion of the body of the filter media extends into at least a portion of a thickness of the body of the seal member.

10. The portion of the filter assembly according to claim 9, wherein the portion of the filter media includes a portion of a length of the body of the filter media, wherein the portion of the length of the body of the filter media is approximately equal to about the thickness of the body of the seal member.

11. The portion of the filter assembly according to claim 9 further comprising
means for positioning the endcap upon a mold tool component prior to utilizing the mold tool for connecting the seal member to the end cap.

12. The portion of the filter assembly according to claim 11, wherein the means includes the groove formed by the inner circumferential lip body that interfaces with a locating rib formed by a mold surface of a mold tool component.

13. The portion of the filter assembly according to claim 9, wherein the top surface of the body of the seal member includes
a first portion that is disposed adjacent the bottom surface of the body of the first or upper endcap and an inner surface of the outer circumferential lip, and
a second portion that directly connected to and extends away from the first portion and is not disposed adjacent any of the bottom surface of the endcap.

14. The portion of the filter assembly according to claim 9, wherein the circumferential lip of the seal member includes
an outer surface, and
an inner surface, wherein the inner surface of the circumferential lip of the seal member forms a passage extending through the seal member.

15. The portion of the filter assembly according to claim 14, wherein the inner surface of the circumferential lip of the seal member includes
a first radial surface portion,
a second radial surface portion, and
an axial ledge surface portion connecting the first radial surface portion to the second radial surface portion, wherein the first radial surface portion forms the passage extending through the seal member to include a first diameter, wherein the second radial surface portion forms the passage extending through the seal member to include a second diameter.

16. The portion of the filter assembly according to claim 15, wherein the second diameter is approximately the equal to, but slightly less than the first diameter.

17. The portion of the filter assembly according to claim 15, wherein one or both of the first and second diameters are approximately equal to a diameter of a standpipe.

18. A method for manufacturing at least a sub-assembly of a filter assembly, wherein the sub-assembly includes an endcap and a seal member, wherein the endcap includes a body, an outer circumferential lip connected to a first end of the body and an inner circumferential lip body connected to a second end of the body, wherein the body includes a top surface and a bottom surface, wherein the circumferential lip body defines a groove, wherein the inner circumferential lip body extends away from and beyond the bottom surface of the body of the endcap, the method comprising the steps of:
providing a mold tool component including a surface having a first surface portion and a second surface portion, wherein the first surface portion includes a locating rib extending away from the surface, wherein the second surface portion includes a cavity formed in the surface;
registering the groove of the circumferential lip body of the endcap upon the locating rib extending away from the surface of the mold tool component;
arranging the top surface of the endcap substantially adjacent first surface portion of the mold tool component for providing a material-receiving surface including the bottom surface of the endcap and the second surface portion of the mold tool component; and
depositing material upon the material-receiving surface for forming the seal member.

19. The method according to claim 18 further comprising the steps of:
curing the material for chemically bonding the endcap to the seal member; and
removing the sub-assembly from the mold tool component.

20. The method according to claim 18, wherein, after depositing the material upon the bottom surface and over the lower portion, the material forms a recess that corresponds to a geometry of the circumferential lip body for
frictionally-bonding the endcap to the seal member.

21. The method according to claim 20 further comprises the steps of
curing the material for
chemically bonding the endcap to the seal member.

22. The method according to claim 18 further comprising the steps of
arranging a portion of a body of a filter media in at least a portion of a thickness of the material that forms a body of the seal member for
permitting the material to flow into and impregnate the portion of the body of the filter media for joining the filter media to the sub-assembly for forming a portion of the filter assembly.

23. The method according to claim 22 further comprising the steps of:
curing the material for chemically bonding the endcap to the seal member as well as the filter media to the seal member; and
removing the portion of the filter assembly from the mold tool component.

24. A method for manufacturing at least a portion of a filter assembly, wherein the sub-assembly includes an endcap and a seal member, wherein the endcap includes a body, an outer circumferential lip connected to a first end of the body and an inner circumferential lip body connected to a second end of the body, wherein the body includes a top surface and a bottom surface, wherein the circumferential lip body defines a groove, wherein the inner circumferential lip body extends away from and beyond the bottom surface of the body of the endcap, the method comprising the steps of:
providing a mold tool component including a surface having a first surface portion and a second surface portion, wherein the first surface portion includes a locating rib extending away from the surface, wherein the second surface portion includes a cavity formed in the surface;
registering the groove of the circumferential lip body of the endcap upon the locating rib extending away from the surface of the mold tool component;
arranging the top surface of the endcap substantially adjacent first surface portion of the mold tool component for providing a material-receiving surface including the bottom surface of the endcap and the second surface portion of the mold tool component; and
arranging a portion of a body of a filter media substantially adjacent the bottom surface of the endcap, wherein a portion of a length of the body of the filter media is approximately equal to about a length of the outer circumferential lip of the endcap;
depositing material upon the material-receiving surface for forming the seal member, wherein the material flows into and impregnates the portion of the body of the filter media.

25. The method according to claim 24 further comprising the steps of:
curing the material for chemically bonding the endcap to the seal member for creating a the sub-assembly of the filter assembly.

26. The method according to claim 24, wherein, after depositing the material upon the bottom surface and over the lower portion, the material forms a recess that corresponds to a geometry of the circumferential lip body for
frictionally-bonding the endcap to the seal member.

27. The method according to claim 26 further comprises the steps of
curing the material for
chemically bonding the endcap to the seal member.

28. The method according to claim 24 further comprising the steps of:
curing the material for chemically bonding the endcap to the seal member as well as the filter media to the seal member; and
removing the portion of the filter assembly from the mold tool component.
